(19) United States
(12) Patent Application Publication
(10) Pub. No.: US 2020/0346892 A1
(43) Pub. Date: Nov. 5, 2020

(54) METHOD AND APPARATUS FOR DETECTING THE POSITION OF AN ELEVATOR

(71) Applicant: Otis Elevator Company, Farmington, CT (US)

(72) Inventors: Ergün Alkan, Berlin (DE); Helmut Lothar Schroeder-Brumloop, Berlin (DE)

(21) Appl. No.: 16/864,450

(22) Filed: May 1, 2020

(30) Foreign Application Priority Data
May 3, 2019 (EP) 19172655.3

(51) Int. Cl. B66B 1/34

(52) U.S. Cl. CPC B66B 1/3492; B66B 1/3446; B66B 1/3476

(57) ABSTRACT

An elevator system (1) includes a load sensor (4, 24, 34, 44), a flexible member (2, 18, 22) and an elevator unit (10, 20, 28) arranged to move vertically in a hoistway. The system is arranged such that the load sensor (4, 24, 34, 44) detects a load from at least a fraction of the flexible member (2, 18, 22) and the fraction of the flexible member (2, 18, 22) that applies load to the load sensor (4, 24, 34, 44) changes as the elevator unit (10, 20, 28) moves vertically in the hoistway. The system further includes a non-volatile memory, arranged to store load conversion information for converting the detected load into an elevator unit position.

### FOREIGN PRIORITY

This application claims priority to European Patent Application No. 19172655.3, filed May 3, 2019, and all the benefits accruing therefrom under 35 U.S.C. § 119, the contents of which in its entirety are herein incorporated by reference.

### TECHNICAL FIELD

This disclosure relates to sensing the position of an elevator car within an elevator system using a load sensor.

### BACKGROUND

It is known in the art to detect the position of an elevator car by using magnetic, optical, or other suitable sensors located on the elevator car to detect visible structures within the hoistway, such as magnets or vanes mounted on fixed elements in the hoistway, for example to the hoistway wall, or to use a rotary encoder located on the drive sheave of the elevator system. After power loss within an elevator system, elevator car position information may be lost, for example because the elevator car may have moved during the period of power loss, and this position change might not have been recorded by the elevator system.

Since position information for the elevator system is lost in the event of a power shutdown, the elevator system must cause the elevator car to carry out a “correction run” following a power shutdown. In a correction run the elevator car travels to one or both of the extremities of the car travel space (e.g. the length of the hoistway) in order to restore the position information of the elevator car.

In the event of an emergency within a building, such as a fire or an earthquake, it is not allowed or desirable from a safety point of view, as well as a code point of view, for the elevator car to perform a correction run, as this would potentially endanger the life of passengers or emergency personnel within the car or the car itself. For example, in Europe, systems are required to comply with certain safety codes covering emergency fire operation (EFO) of standard passenger and goods elevators and emergency fire service (EFS) operation of firefighter elevators which can be used and controlled by firefighters during a fire. Such codes may prohibit correction runs of elevator cars, so as to minimise exposure of passengers to danger.

### SUMMARY

According to a first aspect of this disclosure there is provided an elevator system comprising: a load sensor; a flexible member; and an elevator unit arranged to move vertically in a hoistway; the load sensor, flexible member and elevator unit being arranged such that the load sensor detects a load from at least a fraction of the flexible member; and arranged such that the fraction of the flexible member that applies load to the load sensor changes as the elevator unit moves vertically in the hoistway; and further comprising a non-volatile memory, arranged to store load conversion information for converting the detected load into an elevator unit position.

According to a second aspect of this disclosure there is provided a method of sensing the position of an elevator unit arranged to move vertically in a hoistway, comprising: detecting, by a load sensor, a load which depends on at least a fraction of a flexible member, wherein the fraction of the flexible member that applies load to the load sensor changes as the elevator unit moves vertically in the hoistway; reading from a non-volatile memory conversion information for converting the detected load into an elevator unit position and thereby determining the elevator unit position.

By measuring a load applied by a fraction of a flexible element, which varies as the elevator unit moves vertically in the hoistway, the stored conversion information can be used to determine the position of the elevator unit within the hoistway. The system can therefore determine the position of the elevator unit simply and accurately. Moreover, the position of the elevator unit can be determined immediately following a power shut-down without the need for a correction run, since the length (and weight) of the fraction of the flexible member applying load to the load sensor are dependent on absolute position within the hoistway and because the previous conversion information which is stored in the non-volatile memory is preserved during power shutdown and can therefore be used to determine the position of the elevator unit immediately when required.

It will be clearly understood by the skilled person that the term “fraction” refers to a part of the overall length of the flexible member. As the elevator unit moves in the hoistway, the flexible member is moved, therefore altering the lengths of the different sections of the flexible member, such that a bigger or smaller fraction of the overall length of the flexible member is present in a particular “section”. For example, if the flexible member is a suspension element then the length of the flexible member directly above the car varies as the elevator car moves. Load is applied to the load sensor by a particular section of the flexible member; as the elevator unit moves, the fraction of the overall length of flexible member which comprises the particular section applying load to the load sensor changes, and therefore so too does the weight of that section of flexible member and so the load detected by the load sensor therefore varies as the elevator unit moves vertically in the hoistway.

In some examples the load detected by the load sensor varies positively with the elevator position, such that as the height of the elevator within the hoistway increases, so too does the load detected by the load sensor. Alternatively, in other examples, the load detected by the load sensor varies negatively with the elevator height such that as the height of the elevator in the hoistway increases, the load detected by the load sensor decreases.

The flexible member may optionally comprise a suspension element, arranged to suspend the elevator unit. The load sensor may be arranged to detect a length of the suspension element directly above the elevator unit.

Alternatively, the flexible member may comprise a flexible member having a first end attached to the elevator unit and arranged such that as the elevator unit travels vertically in the hoistway the length of the flexible member hanging from the elevator unit varies (i.e. the fraction of the flexible member that applies load to the load sensor changes). The load sensor may be arranged to detect a load which depends on the length of the flexible member hanging from the elevator unit, i.e. the length of the flexible member hanging from the elevator unit is the fraction of that flexible member that applies a load to the load sensor. The load sensor may be arranged to detect a load that depends only on the weight of the flexible member.

The elevator system may comprise a first flexible member and a second flexible member. The first flexible member may comprise a suspension element, arranged to suspend the elevator unit. The second flexible member may comprise a flexible member, having a first end attached to the elevator unit and arranged such that as the elevator unit travels vertically in the hoistway the length of the flexible member hanging from the elevator unit varies. The load sensor may be arranged such that the load depends on the length of the suspension element directly above the elevator unit, or on the length of the flexible member hanging from the elevator unit. In some examples the load sensor is arranged such that the load depends on both the length of the suspension element directly above the elevator unit and on the length of the flexible member hanging from the elevator unit. As the elevator unit travels vertically in the hoistway, the lengths of both the first flexible element and the second flexible element may change.

According to an alternative aspect of this disclosure there is provided an elevator system comprising: an elevator unit arranged to move vertically in a hoistway, a flexible member, having a first end attached to the elevator unit and arranged such that as the elevator unit travels vertically in the hoistway the length of the flexible member hanging from the elevator unit varies; a load sensor configured to detect a load, wherein the load depends on the length of the flexible member hanging from the elevator unit; and further comprising a non-volatile memory, arranged to store load conversion information for converting the detected load into an elevator unit position.

According to an alternative aspect of this disclosure there is provided a method of sensing the position of an elevator unit arranged to move vertically in a hoistway, comprising: detecting, by a load sensor, a load which depends on the length of a flexible member hanging from the elevator unit, wherein the flexible member has a first end attached to the elevator unit such that as the elevator unit travels vertically in the hoistway the length of the flexible member hanging from the elevator unit varies; reading from a non-volatile memory conversion information for converting the detected load into an elevator unit position and thereby determining the elevator unit position.

According to an alternative aspect of this disclosure there is provided an elevator system comprising: an elevator unit arranged to move vertically in a hoistway, a first flexible member, having a first end attached to the elevator unit and arranged such that as the elevator unit travels vertically in the hoistway the length of the flexible member hanging from the elevator unit varies; a second flexible member suspending the elevator unit in the hoistway in a 1:1 or 2:1 roping arrangement; a load sensor configured to detect a load, wherein the load depends on at least one of: i) the length of the first flexible member hanging from the elevator unit, and ii) the length of the second flexible member suspending the elevator unit; and further comprising a non-volatile memory, arranged to store load conversion information for converting the detected load into an elevator unit position.

According to an alternative aspect of this disclosure there is provided a method of sensing the position of an elevator unit arranged to move vertically in a hoistway, comprising: detecting, by a load sensor, a load which depends on at least one of: i) the length of a first flexible member hanging from the elevator unit, and ii) the length of a second flexible member suspending the elevator unit, wherein the first flexible member has a first end attached to the elevator unit such that as the elevator unit travels vertically in the hoistway the length of the flexible member hanging from the elevator unit varies; and wherein the second flexible member suspends the elevator unit in the hoistway in a 1:1 or 2:1 roping arrangement; the method further comprising: reading from a non-volatile memory conversion information for converting the detected load into an elevator unit position and thereby determining the elevator unit position.

The elevator unit may be an elevator car or an elevator counterweight. As the position of the elevator car and elevator counterweight are generally directly related, determining the position of one will generally determine the position of the other. Therefore, while the main goal of this disclosure is to determine the position of the elevator car, it will be appreciated that this may be achieved by determining the position of the elevator counterweight. In addition, in some installations, it may be beneficial to determine the position of the elevator counterweight itself. For example, in installations where the elevator counterweight comprises rechargeable batteries, it may be desirable to align the elevator counterweight with a charging point or other power connection so as to transfer power to or from the battery.

It will be clearly understood by the skilled person that the term “hanging from” the elevator unit refers to the weight of a portion of the flexible member acting with a downwards force on the elevator unit. In some examples, the flexible member may hang down from the elevator unit and have sufficient length that it always reaches the floor of the hoistway, regardless of the elevator unit position. In such examples, as the elevator unit moves down the hoistway, the flexible member collects on the floor of the hoistway such that the hoistway floor supports more of its weight and the elevator car supports less of its weight. Thus the weight sensed by the load sensor is dependent on the height of the elevator unit within the hoistway. However, such arrangements require space for the flexible member to collect on the hoistway floor and such space is often used for other system components or for maintenance. In other examples the first end of the flexible member could be affixed to, and hang, from the elevator unit (e.g. from the top surface of the elevator unit, or from the bottom surface of the unit, or indeed any intermediate point on the elevator unit), while a second end of the flexible member may be affixed to a fixed structure in the hoistway (e.g. a hoistway wall or a machine room) in what could be called a “catenary” arrangement. Preferably the second end of the flexible member is affixed to a fixed structure within the upper half of the hoistway. It will be appreciated that the flexible member must, in the majority of elevator unit positions, hang between the two fixing points such that its weight is distributed between the two fixing points. In most cases the flexible member will have at least a portion that hangs “below” the unit, where it will be understood that “below” refers to the flexible member being (at least in part) lower in the hoistway than the bottom surface of the elevator unit, in a standard operating position within the hoistway. The flexible member is thus at least partially located between the lowest surface of the elevator unit and the floor of the hoistway, and may hang at least partly within the vertical “footprint” of the elevator unit.

It will be clearly understood by the skilled person that the term “directly above” refers to a portion of the suspension element which is vertically above the elevator car, and sits within the car's vertical footprint. The suspension element located directly above the elevator car supports the weight of the elevator car or counterweight. This portion of suspension element “directly above” the elevator unit could be directly fixed at one end either to the elevator unit or to a fixed structure in the hoistway. At least one portion (i.e. variable fraction) of the suspension element may extend between the load sensor and the elevator unit. In such cases the load detected by the load sensor depends on (i.e. includes) the weight of this portion of suspension element. As the elevator unit moves vertically within the hoistway, the length of suspension element (and thus its weight) between the load sensor and the elevator unit changes and thus the load sensed by the load sensor changes.

In the case of a flexible member which is a suspension element, as the elevator unit moves within the hoistway, the length of suspension element directly above the elevator unit changes. The greater the height of the elevator unit within the elevator system, the shorter the length of the suspension element directly above the elevator unit. In some examples the load detected by the load sensor has a substantially linear relationship with the length of the suspension element directly above the elevator unit, so that as the length of the suspension element (i.e. the height of the elevator unit) varies, the load detected by the load sensor varies approximately proportionally. However, the two values need not vary proportionally because the load detected by the load sensor could include other loads, for example the load of the elevator unit, which offsets the load detected from being exactly proportional with the distance of travel of the elevator unit, although the relationship would still be linear. Such examples will be described further below. In other examples the relationship between load and position could be non-linear, e.g. due to other non-linear loads, or if the suspension element does not have a uniform weight per unit length. In some examples the load detected by the load sensor has a positive relationship with the length of suspension element directly above the elevator unit, optionally a positive, substantially linear relationship, so that as the length of suspension element directly above the unit increases, the load detected by the load sensor increases (“positive” meaning that the relationship has a positive gradient).

For a flexible member having a first end attached to the elevator unit, the flexible member should be long enough that it permits movement of the elevator unit through the whole range of movement of the elevator unit without stretching or without substantial stretching, such that there is always at least a portion of the flexible member that hangs lower than the lower of the two fixing points (i.e. lower than the first and second ends).

It will be clearly understood by the skilled person that there may be several parallel flexible members, or that a flexible member may comprise one or more sub-members, extending in parallel paths between the same fixing points.

As the elevator unit moves within the hoistway, the distribution of the weight of the flexible member changes between its two end points, i.e. for example, in the case of a flexible member having a first end attached to the elevator unit and a second end attached to a hoistway structure, the distribution of weight between the elevator unit and the hoistway structure changes, i.e. the length of the flexible member hanging from the elevator unit varies. The greater the height of the elevator unit within the elevator system, the longer the length of the flexible member hanging from the elevator unit, and therefore the greater the load acting on the elevator unit (whilst correspondingly less load is taken by the hoistway structure). In some examples the load detected by the load sensor has a substantially linear relationship with the length of the flexible member hanging from the elevator unit, so that as the length of the flexible member (i.e. the height of the elevator unit) varies, the load detected by the load sensor varies approximately proportionally. However, the two values need not vary proportionally because the load detected by the load sensor could include other loads, for example the load of the elevator unit, which offset the load detected from being exactly proportional with the distance of travel of the elevator unit, although the relationship would still be linear. Such examples will be described further below. In other examples the relationship between load and position could be non-linear, e.g. due to other non-linear loads, or if the flexible member does not have a uniform weight per unit length.

In some examples the load detected by the load sensor has a positive relationship with the length of flexible member hanging from the elevator unit, optionally a positive, substantially linear relationship, so that as the length of flexible member hanging from the unit increases, the load detected by the load sensor increases (“positive” meaning that the relationship has a positive gradient).

Alternatively, in other examples the load detected by the load sensor has a negative (i.e. inverse) relationship with the length of flexible member hanging from the unit, so that as the length of flexible member hanging from the unit increases, the load detected by the load sensor decreases. For example, this will be the case if the load sensor is configured to measure a load which includes the weight of the second end of the flexible member, which is attached to a structure in the hoistway. The less of the flexible member that is hanging from the elevator unit, the more that will be hanging from the structure in the hoistway, and hence the higher the load detected by the sensor, giving a negative relationship.

In some examples the load consists of only the weight of the flexible member e.g. the weight of the flexible member hanging from the elevator unit. In other examples the load comprises the weight of the flexible member, the weight of the elevator unit and, where the elevator unit is an elevator car, the weight of any passengers or other temporary load present within the elevator car. This is further advantageous since in many elevator systems a load sensor is already arranged in the elevator system in such a position so as to measure these loads, and therefore the position of the elevator unit can be determined according to the present disclosure without the need for an additional load sensor component. Optionally the elevator system is arranged to measure, in use, the load of passengers within an elevator car, and to store the load of the passengers in the non-volatile memory. Such storing may be performed at regular intervals. Optionally, in this or other examples, a compensation flexible member (e.g. a rope, cable, chain, belt, etc.) may be attached to the elevator unit. The compensation flexible member is discussed further below. In such cases, the load may include the weight of the compensation flexible member hanging from the unit. In some examples, the elevator unit is an elevator counterweight and the load comprises the weight of the elevator counterweight and the weight of a compensation flexible member hanging from the elevator counterweight.

In some examples the elevator system comprises a suspension element (first flexible member), arranged to suspend the elevator unit and a second flexible member having a first end attached to the elevator unit and arranged such that as the elevator unit travels vertically in the hoistway the length of the flexible member hanging from the elevator unit varies. In such examples the load can comprise various loads as described in the preceding paragraph. The load can also include the load applied by both a fraction of the first flexible member and a fraction of the second flexible member.

In some examples the load applied by the first flexible member has a negative relationship with the height of the elevator unit i.e. the load applied by the flexible member decreases as the height of the elevator unit in the hoistway increases. In some examples the load applied by the second flexible member has a positive relationship with the height of the elevator unit i.e. as the height of the elevator unit in the hoistway increases so too does the load applied by the second flexible member. In such cases the loads applied by the first flexible member and the second flexible member will partially offset each other. In such cases it is desirable that the load applied by the first flexible member does not precisely offset the load applied by the second flexible member. It will be appreciated that this means that the two flexible elements do not have exactly opposing effects that would cancel each other out at all elevator unit positions throughout the hoistway, but that they may balance exactly at one specific elevator unit height (while not balancing at any other elevator unit heights) within the hoistway.

Optionally the flexible member could be any rope, cable, chain, belt, or other similar flexible member. The flexible member could be an additional component added to the system primarily for position detection, however preferably the flexible member is an existing component of the elevator system. Optionally the flexible member is a cable for power and/or communications within the elevator system, sometimes referred to as a “travelling cable”. The flexible member may be connected to a wall of the hoistway and may optionally be in connection with a controller of the elevator system.

Optionally the conversion information comprises a formula, which gives the position of the elevator unit in the hoistway based on the detected load. This advantageously allows an accurate elevator unit position to be calculated for any observed load values, without the non-volatile memory having to store a large number of load values and corresponding elevator unit positions.

Alternatively, the conversion information may comprise load calibration values which represent the load, detected by the load sensor, in at least two known elevator unit positions, and the non-volatile memory may then be arranged to store the load calibration values in association with the corresponding elevator unit position information. Therefore, in some examples, the method disclosed may further comprise the step of detecting the load in at least two elevator unit positions within the hoistway to give load calibration values. Preferably the load calibration values are configured (i.e. stored) only during a calibration procedure. Such a procedure may be performed during the initial installation of the elevator system and optionally can also be performed any time a key component of the system is replaced, e.g. a component that affects the load being sensed. For example, a new calibration may be performed when the flexible member, compensation flexible member, main suspension element, etc. is replaced.

Optionally load calibration values are recorded for a plurality of elevator positions along the entire travel space of the elevator unit within the hoistway, spaced apart by no more than 1 m, preferably by no more than 50 cm, more preferably spaced apart by no more than 10 cm. This advantageously allows for accurate determination of the position of the elevator unit at any position within the travel space of the hoistway. Optionally the load calibration values are measured at each floor within the elevator travel space. This advantageously allows the elevator system to take a load measurement whilst the unit is stationary at each floor, thereby preventing any movement of the unit from altering the load measurement. Such values can also readily be verified during normal operation or maintenance inspection if desired. Such examples are particularly applicable where the elevator unit is an elevator car as the load can be expected to change regularly each time passengers (and/or cargo) embark or disembark.

Optionally the elevator system position may be determined to be the elevator position corresponding to the load calibration value stored in the memory which is the closest value to the load measured by the load sensor. Alternatively, the elevator system could interpolate or extrapolate the load calibration values stored in the non-volatile memory to provide position determination at a higher resolution than the stored values.

Optionally the elevator system could be arranged in a 1:1 roping arrangement. In such arrangements the main suspension element is connected directly between the elevator car and a counterweight such that passing a certain length of suspension element over the traction sheave results in corresponding increase/decrease in height of each of the elevator car and elevator counterweight. Alternatively the elevator system could be arranged in a 2:1 roping arrangement. In such arrangements the suspension element is affixed at each end to the hoistway (typically affixed to the roof of the hoistway via a dead-end hitch) with the elevator car and elevator counterweight each suspended therefrom via a pulley. In such arrangements passing a certain length of suspension element over the traction sheave results in a change in height of half that length for each of the elevator car and elevator counterweight. In a 1:1 roping arrangement, if the load sensor is arranged to sense the load in the suspension element then it may be positioned at the end of the suspension element near to the attachment to either the elevator car or elevator counterweight. In a 2:1 roping arrangement, if the load sensor is arranged to sense the load in the suspension element then it may be positioned at either end of the suspension element near the point of attachment to the hoistway, e.g. at the dead-end hitch. This may be either the end nearest the elevator car or the end nearest the elevator counterweight.

Features of any aspect or example described herein may, wherever appropriate, be applied to any other aspect or example described herein. Where reference is made to different examples or sets of examples, it should be understood that these are not necessarily distinct but may overlap.

### DRAWING DESCRIPTION

Certain preferred examples of this disclosure will now be described, by way of example only, with reference to the accompanying drawings, in which:

FIG. 1 shows a first example of an elevator system according to the present disclosure.

FIG. 2 shows a second example of an elevator system according to the present disclosure, arranged in a 1:1 roping arrangement.

FIG. 3 shows a third example of an elevator system according to the present disclosure, arranged in a 2:1 roping arrangement.

FIG. 4 shows a fourth example of an elevator system according to the present disclosure, arranged in a 2:1 roping arrangement.

### DETAILED DESCRIPTION

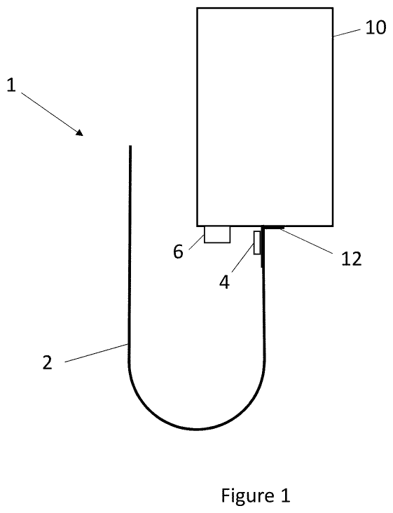

FIG. 1 shows an elevator system 1 according to the present disclosure. The elevator system includes an elevator car 10, arranged within an elevator hoistway (not shown). A load cell controller 6 is attached to the bottom surface of the elevator car 10, i.e. the surface nearest to the floor of the hoistway. A flexible member (which in this non-limiting example is a travelling cable 2, i.e. a cable that typically carries power and/or communications to/from the elevator car 10) is also attached to the bottom surface of the car 10 by a fixing bracket 12. The other end of the travelling cable 2 is connected to a structure within the hoistway, which is not shown in the Figure. For example, the travelling cable 2 could be connected to an elevator controller which could be fixed at the top of the hoistway. A load sensor 4 is fitted to the travelling cable at the end that is attached to the elevator car 10 so that it measures the load of the travelling cable 2 that hangs below the elevator car 10.

As the elevator car 10 moves up the hoistway, the length of travelling cable 2 hanging below the elevator car 10 increases, and therefore the load value read by the load sensor 4 will increase. Similarly, as the elevator car 10 descends in the hoistway, more of the cable weight will be suspended from the hoistway structure (not shown) holding up the left hand part of the cable 2 (as shown in the Figure), and therefore a smaller amount of cable 2 will be hanging below the car 10, and hence the reading of the load sensor 4 will decrease.

The principle of the present disclosure is to convert the detected or measured load from the load sensor and convert that into an elevator position based on stored conversion information. As discussed earlier, this could be via a stored formula or it could be achieved by measuring the load value at a plurality of different elevator car positions, and storing each load value and its corresponding elevator position within a memory. Then, in use, the load sensor 4 can measure the load of the travelling cable 4 hanging below the elevator car 10, compare this to the stored values, and can determine the position of the elevator car 10 to be the position which corresponds to the stored load value which is closest to the load value currently measured by the load sensor 4 or can determine the elevator car position more accurately by interpolating or extrapolating from the stored load values. For example, if the measured load is halfway between the load values measured at two adjacent floors, then the elevator system can establish that the elevator system is positioned halfway between these floors (in cases where the relationship is linear).

It will be appreciated that the principles described above apply equally to an example where the elevator car 10 is replaced with an elevator counterweight.

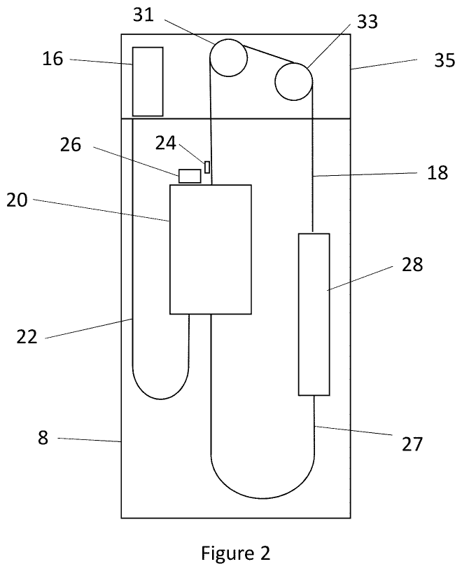

FIG. 2 shows an example of an elevator system according to the present disclosure. The elevator system is arranged in a 1:1 roping arrangement in which the suspension element 18 is connected directly between the elevator car 20 and the counterweight 28. The suspension element 18 could be one or more suspension ropes or cables or could alternatively be one or more belts, e.g. coated steel belts. This Figure shows the elevator car 20 located within the hoistway 8. Similar to FIG. 1, a travelling cable 22 is connected at a first end to the bottom surface of the elevator car 20, i.e. the surface closest to the floor of the hoistway 8. The travelling cable 22 is connected at its second end to an elevator controller 16. The elevator car 20 is suspended by suspension element 18 which connects at one end to the elevator car 20 and at the other end to a counterweight 28. The suspension element passes over a traction sheave 31 and a diverting sheave 33, which, together with the controller 16, are located within a machine room 35. A compensation chain 27 connects the bottom of the counterweight 28 to the bottom of the elevator car 20. A compensation chain 27 is present in many elevator systems, and connects the bottom surface of an elevator car 20 to a counterweight 28. It is arranged to compensate (or partially compensate) for the weight of the suspension element 18 which connects the top of the elevator car 20 and counterweight 28, such that the overall weight on either side of the drive traction 31 does not vary significantly during movement of the elevator car 20. In some elevator systems the compensation chain 27 compensates exactly for the weight of the suspension element 18. Alternatively in some examples the compensation chain 27 only partially compensates for the weight of the suspension element 18. Alternatively the compensation chain may be completely absent from the elevator system, leaving the weight of the suspension element totally uncompensated.

As the elevator car 20 moves within the hoistway, the combined weight of the suspension element 18 and the compensation chain 27 on each side of the traction sheave 31 and diverting sheave 33 remain substantially constant (or at least vary to a lesser extent than they would in the absence of the compensation chain 27), thus reducing risks of slippage.

In this example a load cell controller 26 is located on the top surface of the elevator car 20, i.e. the surface nearest to the ceiling of the hoistway 8, and a load cell 24 is connected to the suspension element 18, between the point at which the suspension element 18 is joined to the elevator car 20 and the point at which the elevator suspension element contacts the traction sheave 31. It will be appreciated that the load cell 24 should be arranged close enough to the elevator car 20 that it does not interfere with the traction sheave 31 even when the elevator car 20 is near the top of the hoistway 8.

In this example the load detected by the load cell 24 includes the weight of the travelling cable 22 hanging below the elevator car 20, together with the weight of the elevator car 20, the weight of any passengers within the elevator car 20 and the weight of the compensation chain 27 hanging below the car 20.

The weight of the elevator car 20 alone is a known value and can be stored in a non-volatile memory of the elevator system. During operation the elevator system can monitor and store the value of the weight of passengers within the elevator car 20. The weight of passengers and/or cargo changes during use of the elevator system, e.g. as passengers enter or exit the elevator car 20 at the various landings. However, the weight of passengers and/or cargo does not change between floors. Further, the elevator system can determine the change in weight that has occurred while it is stopped at a floor by measuring the weight again after the doors have closed (at which point no further changes in weight should occur until the next floor stop). This updated passenger/cargo weight can then be stored in the non-volatile memory before the elevator car 20 departs for the next floor. In the event of a power loss during travel the elevator system can then reload the stored passenger weight from the non-volatile memory when power is restored and use that information together with the data from the load cell 24 to immediately calculate its current position without having to perform a calibration run.

The weight measured by the load cell 24 therefore changes dependent on both the weight of the travelling cable 22 and the compensation chain 27, hanging below the elevator car 20 and the weight of the passengers and/or cargo. As the elevator car 20 travels up the hoistway 8, the length of both the travelling cable 22 and the compensation chain 27, hanging from the elevator car 20 increase, and therefore the load measured by the load cell 24 increases. The opposite is clearly true as the elevator car 20 descends in the hoistway 8.

In order to calculate the position of the elevator car 20 within the system, the elevator system first carries out a calibration run, in which the empty elevator car 20 travels to various positions within the hoistway 8, possibly to each floor. In each position the load cell 24 measures a load, preferably while the elevator car 20 is stationary. Optionally the weight of the elevator car 20 can be subtracted from each value. These load calibration values are then stored in a non-volatile memory of the elevator system. In use, the elevator system can determine its position by first taking a load measurement using its load cell 24. The known weight of the elevator car 20, and the load of the passengers and cargo (as stored in the non-volatile memory by the elevator system) are subtracted from the measured weight. The resulting value is then compared to the stored calibration values, and the closest calibration value identified. The position of the elevator car is either taken to be the position corresponding to the closest calibration load value, or can be interpolated or extrapolated from the stored values.

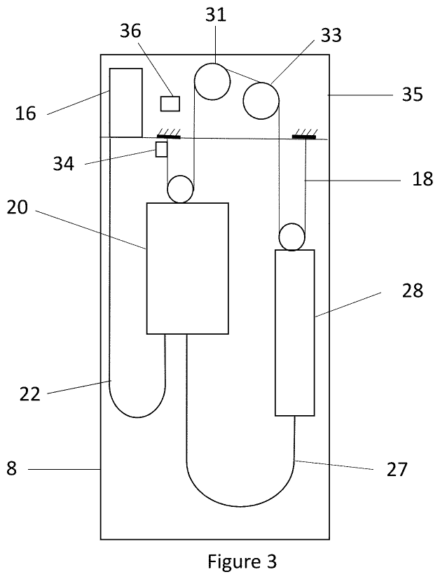

FIG. 3 shows an example of an elevator system according to the present disclosure. The elevator system is arranged in a 2:1 roping arrangement in which the ends of the suspension element 18 are fixed to the ceiling of the hoistway 8 via dead-end hitches. This Figure shows the elevator car 20 located within the hoistway 8. Similar to FIGS. 1 and 2, a travelling cable 22 is connected to the bottom surface of the elevator car 20, i.e. the surface closest to the floor of the hoistway 8. The travelling cable 22 is connected at its second end to an elevator controller 16. The elevator car 20 is suspended by suspension element 18 which attaches at one end to a dead-end hitch in the machine room 35, passes around a sheave of the elevator car 20, then passes over a traction sheave 31 and a diverting sheave 33, around a sheave of a counterweight 28, and attaches to another dead-end hitch in the floor of machine room 35. The traction sheave 31, the diverting sheave 33 and the controller 16 are located within the machine room 35. A compensation chain 27 connects the bottom of the counterweight 28 to the bottom of the elevator car 20.

A load cell 34 is arranged to detect the load in the suspension element 18 between the point at which the first end of the suspension element 18, nearest the elevator car 20, is fixed to the floor of the machine room 35, and the point at which the suspension element 18 meets the top of the elevator car 20. The load cell 34 is connected to a load cell controller 36.

In this example the position determination system works similarly to the system described with reference to FIG. 2. However, in this case, the load measured by the load cell 34 will depend on the weight of the travelling cable 22 hanging below the car 20, the weight of the compensation chain 27, the weight of the portion of suspension element 18 hanging below the load cell 34 and above the elevator car 20, the weight of the car 20 and the weight of any passengers and/or cargo within the car 20. As described above the weight of the compensation chain 27 may compensate for the weight of the suspension element 18, or may partially compensate for it. Alternatively the compensation chain may be completely absent in the elevator system leaving the weight of the suspension element totally uncompensated. Where the compensation chain 27 only partially compensates for the changing weight of the suspension element 18 there will still be a difference in weight as the elevator car 20 moves such that the total weight of all flexible members changes with the changing position of the elevator car 20.

As the elevator car 20 descends in the hoistway 8, less of the travelling cable 22 hangs below the elevator car 20. The compensation chain 27 is lifted by the counterweight 28, which rises, so that less of the compensation chain 27 hangs below the elevator car 20. As the elevator car 20 descends, the length of suspension element 18 hanging below the load cell 34 and above the elevator car 20 increases. If the decrease in the hanging length of compensation chain 27 fully compensates for the increased length of the suspension element 18 then the load measured by the load cell 34 depends only on the length of travelling cable 22 hanging below the elevator car 20. Otherwise, the load measured by the load cell 34 will depend on the travelling cable 22, the compensation chain 27 and the length of suspension element 18 hanging below the load cell 34.

The load cell 34 will also measure the weight of the elevator car 20 and the weight of any of its passengers and/or cargo, but these values are known to the elevator system (and stored in the non-volatile memory) and can be subtracted from the measured value as previously described. The weight of the empty elevator car 20 is a constant that can be measured once and stored in the system with the expectation that it will not change. The weight of the passengers and/or cargo can be monitored by the elevator system as previously described with reference to FIG. 2.

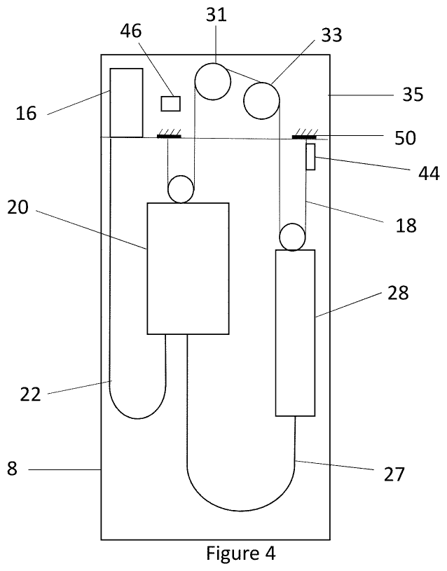

FIG. 4 shows another example of an elevator system according to the present disclosure. The elevator system is arranged in a 2:1 roping arrangement like that of FIG. 3. The elevator car 20 is located within a hoistway 8. A travelling cable 22 connects the bottom of the elevator car 20 to a controller 16, located within a machine room 35. A travelling cable 22 is connected to the bottom surface of the elevator car 20, i.e. the surface closest to the floor of the hoistway 8. The travelling cable 22 is connected at its second end to an elevator controller 16. The elevator car 20 is suspended by suspension element 18 which attaches at one end to a dead-end hitch in the machine room 35, passes around a sheave of the elevator car 20, then passes over a traction sheave 31 and a diverting sheave 33, around a sheave of a counterweight 28, and attaches to another dead-end hitch 50 in the floor of machine room 35. The traction sheave 31, the diverting sheave 33 and the controller 16, are located within the machine room 35. A compensation chain 27 connects the bottom of the counterweight 28 to the bottom of the elevator car 20. Alternatively the compensation chain could be completely absent in the elevator system leaving the weight of the suspension element totally uncompensated.

A load sensor 44 is connected to the suspension element 18, between the point 50, known as the dead-end hitch and the point where the suspension element 18 meets the top of the counterweight 28. The load cell, or load sensor 44, is controlled by load cell controller 46.

In this example the load measured by the load sensor 44 includes the weight of the counterweight 28, the weight of the compensation chain 27 which hangs below the counterweight 28, and also the weight of the length of suspension element 18 which hangs below the load sensor 44. As the elevator car 20 descends in the hoistway 8, the counterweight 28 rises, hence the length of compensation chain 27 hanging below the elevator car decreases and therefore the length of the compensation chain 27 hanging below the counterweight 28 increases. As the counterweight 28 rises, the length of suspension element 18 hanging below the load sensor 44 decreases. If the increased length of compensation chain 27 were compensated exactly by the decreased length of suspension element 18, then the weight measured by the load sensor 44 would be unchanged as the elevator car 20 travelled in the hoistway 8. Therefore, in this example in order for such an arrangement to successfully allow position determination of the elevator car 20, the compensation chain 27 is arranged so that the weight of the compensation chain 27 does not exactly compensate for the weight of the suspension element 18. Therefore, similarly to the previously described methods, weight of the counterweight 28 can be subtracted from the load measured by the load sensor 44, and the remaining weight will then depend on the position of the elevator car 20 within the hoistway 8 in such a way that the position of the elevator car 20 can be determined using load calibration values previously measured by the load sensor 44 during a calibration procedure and stored in a non-volatile memory as described above.

It will be appreciated that while certain examples above have been described with reference to a machine room, the principles described here work equally well in machine room-less elevators.

It will be appreciated by those skilled in the art that the invention has been illustrated by describing one or more specific embodiments thereof, but is not limited to these embodiments; many variations and modifications are possible, within the scope of the accompanying claims.

What is claimed is:

1. An elevator system (1) comprising:
a load sensor (4, 24, 34, 44);
a flexible member (2, 18, 22);
an elevator unit (10, 20, 28) arranged to move vertically in a hoistway;
the load sensor, flexible member and elevator unit being arranged such that the load sensor (4, 24, 34, 44) detects a load from at least a fraction of the flexible member (2, 18, 22); and
arranged such that the fraction of the flexible member (2, 18, 22) that applies load to the load sensor (4, 24, 34, 44) changes as the elevator unit (10, 20, 28) moves vertically in the hoistway;
and further comprising a non-volatile memory, arranged to store load conversion information for converting the detected load into an elevator unit position.

2. The elevator system (1) of claim 1, wherein the flexible member comprises a suspension element (18), arranged to suspend the elevator unit (10, 20, 28).

3. The elevator system (1) of claim 1, wherein the flexible member has a first end attached to the elevator unit (10, 20) such that as the elevator unit (10, 20) travels vertically in the hoistway (8) the length of the flexible member (12, 22) hanging from the elevator unit (10, 20) varies.

4. The elevator system (1) of claim 1, wherein the load detected by the load sensor (4, 24, 34, 44) has a substantially linear relationship with the length of the flexible member (12, 22).

5. The elevator system (1) of claim 1, wherein the flexible member comprises a flexible member that has a first end attached to the elevator unit (10, 20) such that as the elevator unit (10, 20) travels vertically in the hoistway (8) the length of the flexible member (12, 22) hanging from the elevator unit (10, 20) varies, and wherein the load detected by the load sensor (4, 24, 34, 44) has a positive relationship with the length of the flexible member (12, 22) hanging from the elevator unit (10, 20).

6. The elevator system (1) of claim 1, wherein the load comprises the weight of the flexible member (12, 22) hanging from the elevator unit (10, 20).

7. The elevator system (1) of claim 1, wherein the load comprises the weight of the elevator unit (10, 20) and the weight of any passengers and/or cargo, and wherein the elevator system (1) is arranged to measure, in use, the load of passengers and/or cargo within the elevator unit (10, 20), and to store the load of the passengers and/or cargo in the non-volatile memory.

8. The elevator system (1) of claim 1, wherein a compensation flexible member (27) is attached to the elevator unit (10, 20, 28), and the load includes the weight of the compensation flexible member (27) hanging from the elevator unit (10, 20, 28).

9. The elevator system (1) of claim 1, wherein the conversion information comprises load calibration values which represent the load, detected by the load sensor (4, 24, 34, 44) in at least two elevator positions, and wherein the non-volatile memory is arranged to store the load calibration values and the corresponding elevator unit position information.

10. A method of sensing the position of an elevator unit (10, 20, 28) arranged to move vertically in a hoistway, comprising:
detecting, by a load sensor (4, 24, 34, 44), a load which depends on at least a fraction of a flexible member (12, 18, 22), wherein the fraction of the flexible member (12, 18, 22) that applies load to the load sensor (4, 24, 34, 44) changes as the elevator unit (10, 20, 28) moves vertically in the hoistway;
reading from a non-volatile memory conversion information for converting the detected load into an elevator unit position and thereby determining the elevator unit position.

11. The method of claim 10, wherein the flexible member (12, 22) has a first end attached to the elevator unit (10, 20) such that as the elevator unit (10, 20) travels vertically in the hoistway (8) the length of the flexible member (12, 22) hanging from the elevator unit (10, 20) varies and the load depends on the length of the flexible member (12, 22) hanging from the elevator unit (10, 20, 28).

12. The method of claim 10, wherein the load detected by the load sensor (4, 24, 34, 44) has a substantially linear relationship with the length of the flexible member (12, 22).

13. The method of claim 10, wherein the flexible member comprises a flexible member that has a first end attached to the elevator unit (10, 20) such that as the elevator unit (10, 20) travels vertically in the hoistway (8) the length of the flexible member (12, 22) hanging from the elevator unit (10, 20) varies, and wherein the load detected by the load sensor (4, 24, 34, 44) has a positive relationship with the length of flexible member (12, 22) hanging from the elevator unit (10, 20).

14. The method of claim 10, wherein the load comprises the weight of the elevator unit (10, 20) and the weight of any passengers and/or cargo, and wherein the method further comprises measuring, by the elevator system (1), of the load of any passengers and/or cargo, and storing the load of the passengers and/or cargo in the non-volatile memory.

15. The method of claim 10, wherein the method further comprises detecting the load in at least two elevator unit positions within the hoistway (8) to give load calibration values and storing these load calibration values in association with the corresponding elevator unit position information in the non-volatile memory.
